(19) United States
(12) Patent Application Publication
(10) Pub. No.: US 2007/0103017 A1
(43) Pub. Date: May 10, 2007

(54) Superconducting generator rotor electromagnetic shield

(75) Inventor: David G. Halsey, Rockford, IL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation One Financial Plaza, Hartford, CT (US)

(21) Appl. No.: 11/271,578

(22) Filed: Nov. 10, 2005

(51) Int. Cl. H02K 9/00; H02K 5/10; H02K 1/22

(52) U.S. Cl. 310/85; 310/52; 310/261

(57) ABSTRACT

A unitary bimetallic shield ring for a superconducting generator rotor includes coaxial inner and outer cylindrical portions. The outer cylindrical portion comprises a first metallic material for conducting eddy currents to dissipate energy, and defines an interior face. The inner cylindrical portion comprises a second metallic material for providing structural support to the outer cylindrical portion. The inner cylindrical portion is continuously metallurgically joined with the interior face of the outer cylindrical portion. The shield is made by first forming a substantially continuous weld between the inner and outer layers, and then machining the shield.

### BACKGROUND OF THE INVENTION

The present invention relates to electromagnetic shielding for superconducting generator rotors.

Superconducting generators include a cryogenically cooled rotor having rotor windings. The rotor is a rotating part that works together with a non-moving stator to produce electrical energy, which can be conditioned to the form of a high-voltage DC output. The superconducting rotor coils must be protected from magnetic flux variation originating in the stator. Such undesired magnetic flux may cause the generation of alternating electrical currents (i.e., eddy currents) in the rotor coils. Those alternating currents generate heat, and can thereby cause the rotor coils to cease to be superconductors.

In order to protect rotor coils from noise, and occasionally to also provide dampening, a number of shields and damper shields have been disclosed. A damper shield disclosed by Sterrett, U.S. Pat. No. 4,039,870, is a two-layer assembly for providing shielding and mechanical dampening. The inner layer is a conductive copper alloy. The outer layer, forming the exterior of the shield, is a structural material. The two layers are welded together using explosive welding. The explosive welding process in conducted by placing the inner layer and outer layer inside one another, and placing an explosive charge inside the inner (copper alloy) layer and detonating it. However, this damper shield has a number of disadvantages. Eddy currents tend to form along exterior surfaces, and therefore an outer non-conductive structural layer lessens the ability of the damper shield to dissipate eddy currents at a distance from the rotor itself. In addition, placing explosive charges inside a cylinder is difficult, particularly where the bore of the cylinder (pre-detonation) is small.

A damper shield disclosed by Cooper et al., U.S. Pat. No. 4,152,609, is a three-layer assembly. The inner and outer layers are non-conductive structural layers and the intermediate layer is a conductive layer. The respective layers are welded together. High-strength non-magnetic materials are specifically used for the outer layer because of mechanical forces concentrated there. The three layers are secured together by metallurgical bonding or mechanical keying. However, the damper shield presents difficulties with respect to the outer layer being non-conductive, which lessens eddy current dissipation capabilities at a distance from the rotor, and difficulties in manufacturing a three-layer assembly. Explosive welding, which can be used to form a metallurgical bond, is problematic where both the inner and outer layers are high-strength materials. Moreover, a mechanically-keyed assembly presents a risk of cracking and other damage during use.

A shielding assembly is also disclosed by Khutoretsky et al., U.S. Pat. No. 4,820,945 for providing only shielding to a rotor. The assembly includes an inner cylinder of conductive material. An outer cylinder is formed of a structural material. A solid film lubricant is disposed between the inner and outer cylinders, and separates those cylinders such that they do not form a unitary, securely-joined structure. However, this shield presents difficulty with respect to poor thermal conduction to dissipate heat from the inner cylinder through the solid film lubricant, and also with respect to lessened eddy current dissipation at a distance from the rotor where the outer cylinder is non-conductive.

The present invention provides an alternative electromagnetic shield for use with a superconducting generator or other dynamoelectric device.

### BRIEF SUMMARY OF THE INVENTION

A unitary bimetallic shield ring for a superconducting generator rotor includes coaxial inner and outer cylindrical portions. The outer cylindrical portion comprises a first metallic material for conducting eddy currents to dissipate energy, and defines an interior face. The inner cylindrical portion comprises a second metallic material for providing structural support to the outer cylindrical portion. The inner cylindrical portion is continuously metallurgically joined with the interior face of the outer cylindrical portion.

Further disclosed is a method of manufacturing a shield. The method includes providing a first cylindrical layer of a high-strength non-magnetic flux conducting metallic material, welding a second cylindrical layer of copper around the first cylindrical layer, and machining the second cylindrical layer to remove a portion of the second cylindrical layer. The weld is substantially continuous at an interface defined between the first cylindrical layer and the second cylindrical layer.

### BRIEF DESCRIPTION OF THE DRAWINGS

FIG. 1 is a longitudinal cross-sectional view of a portion of a superconducting generator system having a shield assembly according to the present invention.

FIG. 2 is a lateral cross-sectional view of a portion of the superconducting generator system, taken along section A-A of FIG. 1, showing the shield assembly and a rotor.

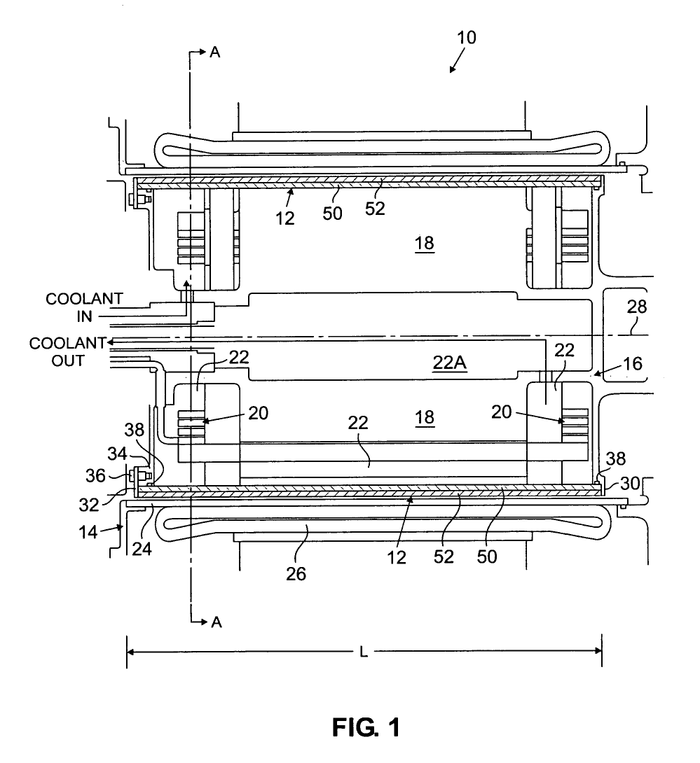

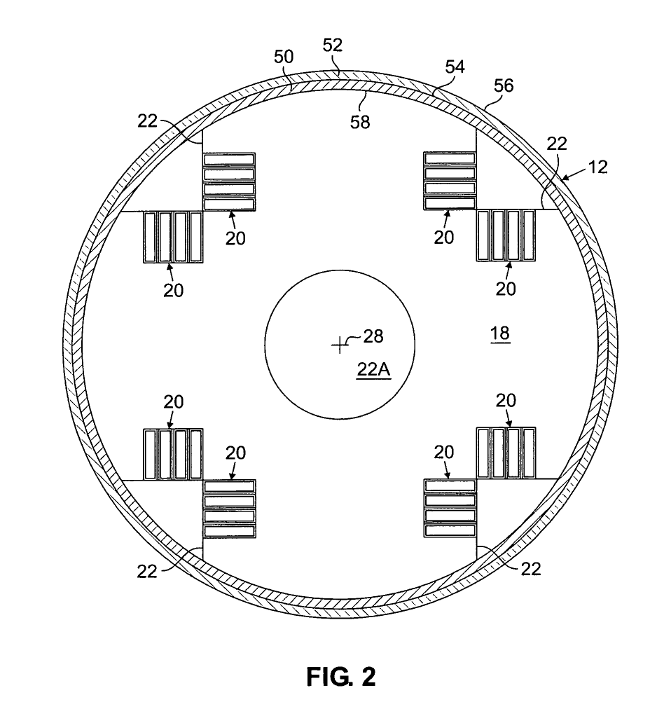

In FIGS. 1 and 2, only the shield assembly has been has been shown cross-hatched in section, and the other components of the superconducting generator system have been shown only schematically for clarity.

### DETAILED DESCRIPTION

The present invention provides an electromagnetic shield for a superconducting generator rotor, or similar device, to shield the rotor's windings from electromagnetic noise, giving rise to eddy currents. In particular high-order harmonics are of a concern, including the 5^{th} and 7^{th} harmonic pair, the 11^{th} and 13^{th} harmonic pair and the 17^{th} and 19^{th} harmonic pair. The 5^{th} and 7^{th} harmonic pair can be addressed using an active rectifier. The shield of the present invention can also be used to dissipate undesired electromagnetic noise to protect the superconducting coils from undesired heating. In one embodiment, the shield of the present invention can intercept about 100 watt losses due to the 11^{th} and 13^{th} harmonics and about 15 watt losses due to the 17^{th} and 19^{th} harmonics, which could otherwise cause the windings to develop local hot spots and cease to be superconductors.

The shield according to the present invention is a cylindrical bimetallic assembly that includes an inner structural layer of a high-strength high electrical resistivity (i.e., nonmagnetic) metallic material and an outer electrically conductive metallic layer. The two layers are metallurgically bonded together to form a unitary shield structure. The outer layer conducts noise currents (i.e., alternating currents or eddy currents) to dissipate them, as heat, at a location spaced from the rotor windings.

FIG. 1 is a longitudinal cross-sectional view of a portion of a superconducting generator system 10 having a shield assembly 12. The system 10 includes a stator 14 and a cryogenically-cooled rotor 16. The rotor 16 includes a shaft structure 18, rotor windings 20, and coolant pathways 22. The coolant pathways allow a cryogenic coolant to enter the rotor 16 and travel through a complex path past the rotor windings 20 and eventually out of the rotor 16 through a central pathway 22A. The stator 14 includes a stator body structure 24 and stator windings 26. The rotor 16 and stator 14 are positioned about an axis of rotation 28 for the generator system 10.

The shield 12 is mounted around a portion of the rotor 16, and is separated from the stator 14 by a small air gap or vacuum gap. The shield 12 is retained on the rotor 16 at both ends of the shield 12. At one end, the shield 12 is placed at support notch 30 of the rotor 16. The support notch 30 restrains longitudinal movement of the shield 12 with an interference fit. At its other end, the shield 12 is secured with a retention plate 32 that is secured to a support flange 34 of the rotor 16 by one or more screws 36. Sealing elements 38 (e.g., OmniSeals®, available from Saint Grobain Performance Plastics, Garden Grove, Calif.) are provided to create a fluid seal between the shield 12 and the rotor 16 at both ends of the shield 12.

FIG. 2 is a lateral cross-sectional view of a portion of the generator system 10, taken along section A-A of FIG. 1, showing the rotor 16 and the shield assembly 12. As shown in FIGS. 1 and 2, the shield 12 is a unitary, bimetallic assembly that includes an inner layer 50 and an outer layer 52, and has an elongate cylindrical shape. The inner layer 50 is a structural layer formed of a high-strength and high electrical resistivity metallic material, such as Inconel® 718 (a high-strength austenitic nickel-chromium-iron alloy) and MP35N® (available from Carpenter Technology Corp., Reading, Pa.). The outer layer 52 is formed of an electrically conductive metallic material having a relatively low resistivity, such as aluminum or copper. The copper can be oxygen-free copper or of a similar grade. In a preferred embodiment, the outer layer 52 is formed of copper, which has beneficial coefficient of expansion properties when used at temperatures where the rotor windings 20 can be superconducting.

The inner and outer layers 50 and 52 are metallurgically joined, for example, using an explosive welding process, to produce a unitary bimetallic shield 12 where the inner and outer layers 50 and 52 are connected by a substantially continuous joint 54 along the interface of those layers. The outer layer 52 forms an exterior surface 56 of the shield 12.

In one embodiment, the shield 12 has the following nominal dimensions. The inner diameter of the of the inner layer 50 is 21.5265 centimeters (cm) (8.475 inches). The outer diameter of the inner layer 50 (and also the inner diameter of the outer layer 52) is 22.2885 cm (8.775 inches). The outer diameter of the outer layer 52 is 23.0505 cm (9.075 inches). The longitudinal length L of the shield 12 is 49.276 cm (19.4 inches). It should be recognized that these dimensions are exemplary and other dimensions are possible, as desired.

In operation, the shield 12 reduces the risk that electromagnetic noise originating at the stator 14 will reach the rotor 16. The electromagnetic noise is dissipated by the process of generating eddy currents in the outer (conductive) layer 52 of the shield 12. Those eddy currents are dissipated as heat by the shield 12, to reduce heating of the rotor 16, and more particularly, to reduce heating of the superconducting rotor core 18 protected by the shield 12.

Also, when the shield 12 is installed on the rotor 16, the high strength inner layer 50 of the shield 12 can provide compressive loading to the rotor 16. This optional compressive loading permits the use of magnetic materials for the rotor core 18 that would otherwise not be acceptable at cryogenic temperatures (i.e., about 40° K or lower).

The shield 12 can be manufactured as follows. A first cylinder corresponding to the inner (structural) layer 50 is provided. Then a second cylinder corresponding to the outer (conductive) layer 52 is positioned around the first cylinder. The second cylinder is slightly larger than the desired nominal finished dimensions of the outer layer 52 of the shield 12. This permits the second cylinder to be more easily fitted over the first cylinder for fabrication. The first and second cylinders are then cleaned as desired. They are then positioned in an appropriate enclosure or pit for explosive welding, and supported for explosive welding. Explosive charges are placed around the second cylinder, relative to an exterior surface of the second cylinder (corresponding to the exterior surface 56 of the outer layer 52 of the shield 12). Explosive welding is conducted by detonating the charges to cause the material of the second cylinder to be metallurgically joined to the material of the first cylinder, and create the shield 12 with a substantially continuous connection between its inner layer 50 (corresponding to the first cylinder) and its outer layer 52 (corresponding to the second cylinder). Finally, the welded shield 12 is machined at its outer surface 56 and its inner surface 58. Machining is performed to achieve desired nominal finished dimensions for the shield. The finished shield can then be mechanically installed on the rotor 16.

It should be recognized that the present invention provides numerous advantages. First, the location of the conductive material of the outer layer at the exterior surface of the shield allows electromagnetic noise to be dissipated at a location spaced from the superconducting windings of a superconducting generator rotor. Moreover, the bimetallic shield of the present invention has its conductive layer radially outside the structural layer, which may facilitate manufacturing.

Although the present invention has been described with reference to several alternative embodiments, workers skilled in the art will recognize that changes may be made in form and detail without departing from the spirit and scope of the invention. For instance, dimensions of the shield can differ from the example given, as desired for particular application. In addition, a shield according to the present invention can be used with generators, induction motors, and other dynamoelectric systems.

What is claimed is:

1. A unitary bimetallic shield ring for a superconducting generator rotor, the ring comprising:
an outer cylindrical portion comprising a first metallic material for conducting eddy currents to dissipate energy, the outer cylindrical portion defining an interior face; and
an inner cylindrical portion comprising a second metallic material for providing structural support to the outer cylindrical portion, wherein the inner cylindrical portion is disposed coaxially with the outer cylindrical portion and is continuously metallurgically joined with the interior face of the outer cylindrical portion, and wherein the inner cylindrical portion is disposed interior of the outer cylindrical portion for mounting to the superconducting generator rotor.

2. The ring of claim 1, wherein the first metallic material is selected from the group consisting of: aluminum and copper.

3. The ring of claim 1, wherein the second metallic material is selected from the group consisting of: Inconel® 718 and MP35N®.

4. The ring of claim 1, wherein a continuous metallurgical weld joint is formed between the outer cylindrical portion and the inner cylindrical portion.

5. A superconducting rotor assembly for use with a generator, the assembly comprising:
a cylindrical rotor body carrying a field winding of superconducting material cooled by a cryogenic coolant; and
a cylindrical bimetallic electromagnetic shield supported around a portion of the rotor body, the shield comprising:
an inner cylindrical layer made of a high-strength and high electrical resistivity metallic material; and
an outer cylindrical layer made of an electrically conductive metallic material selected from the group consisting of copper and aluminum, wherein a substantially continuous welded connection joins the inner cylindrical layer and the outer cylindrical layer, and wherein the outer cylindrical layer forms an exterior surface of the assembly.

6. The assembly of claim 5, wherein the high electrical resistivity metallic material is selected from the group consisting of: Inconel® 718 and MP35N®.

7. A method of making a shield ring for dynamoelectric rotor member, the method comprising:
providing a first cylindrical layer of a high-strength high electrical resistivity metallic material;
welding a second cylindrical layer of copper around the first cylindrical layer, wherein the weld formed is substantially continuous at an interface defined between the first cylindrical layer and the second cylindrical layer; and
machining the second cylindrical layer to remove a portion of the second cylindrical layer.

8. The method of claim 7 and further comprising:
machining the first cylindrical layer to remove a portion of the first cylindrical layer.

9. The method of claim 7, wherein the welding step is performed using an explosive welding process.

10. The method of claim 9, wherein explosives for performing the explosive welding process are positioned relative to an exterior surface of the second cylindrical layer prior to detonation.
